(19) United States
(12) Patent Application Publication
(10) Pub. No.: US 2026/0120131 A1
(43) Pub. Date: Apr. 30, 2026

(54) TRANSPARENT MODELING BASED ON SPECIFIC FEATURES

(71) Applicant: Dell Products L.P., Round Rock, TX (US)

(72) Inventors: Abhishek MISHRA, Bangalore (IN); Omer CHEEMA, Leander, TX (US); Anuj Kirti CHITALIA, Mumbai (IN)

(21) Appl. No.: 18/930,568

(22) Filed: Oct. 29, 2024

(51) Int. Cl. G06Q 30/0202; G06N 20/00; G06T 11/20

(52) U.S. Cl. CPC G06Q 30/0202; G06N 20/00; G06T 11/26

(57) ABSTRACT

In some implementations, a model system may receive item-level data from a first data source and feature-level data from a second data source. The model system may preprocess the item-level data and the feature-level data to correlate historical item data to specific components and features. The model system may train a machine learning model on the historical item data correlated to the specific components and features. The model system may receive, from a user device, input indicating a proposed product configuration. The model system may predict an outcome associated with the proposed product configuration using the machine learning model. The model system may generate instructions for a visualization of the outcome, where the visualization further indicates a plurality of contributions associated with the specific components and features. The model system may output, to the user device, the instructions for the visualization.

### BACKGROUND

Predictive analytics is an important part of strategic planning in various industries. Predictive analytics may include use of machine learning techniques. However, machine learning techniques often result in black box models that lack transparency.

### SUMMARY

Some implementations described herein relate to a device for predicting contributions of feature sets to an outcome using shapley additive explanation (SHAP) values. The device may include one or more processors. The one or more processors may be configured to preprocess product configuration details with item-level information from a plurality of databases to create a preprocessed dataset associated with product configurations. The one or more processors may be configured to train a machine learning model using the preprocessed dataset and a gradient boosting algorithm, wherein the machine learning model includes a classifier and a regression model. The one or more processors may be configured to generate a prediction associated with a proposed product configuration using the machine learning model, wherein the prediction includes a binary output from the classifier and a numerical output from the regression model. The one or more processors may be configured to calculate the SHAP values for individual features within a set of features for the proposed product configuration to determine a contribution of each feature in the set of features to the prediction. The one or more processors may be configured to output an indication of the prediction with the SHAP values.

Some implementations described herein relate to a method. The method may include receiving, by a model system, item-level data from a first data source and feature-level data from a second data source. The method may include preprocessing, by the model system, the item-level data and the feature-level data to correlate historical item data to specific components and features. The method may include training, by the model system, a machine learning model on the historical item data correlated to the specific components and features. The method may include receiving, by the model system and from a user device, input indicating a proposed product configuration. The method may include predicting, by the model system, an outcome associated with the proposed product configuration using the machine learning model. The method may include generating, by the model system, instructions for a visualization of the outcome, wherein the visualization further indicates a plurality of contributions associated with the specific components and features. The method may include outputting, by the model system and to the user device, the instructions for the visualization.

Some implementations described herein relate to a non-transitory computer-readable medium that stores a set of instructions. The set of instructions, when executed by one or more processors of a device, may cause the device to receive input indicating a proposed product configuration. The set of instructions, when executed by one or more processors of the device, may cause the device to provide the input to a machine learning model to generate a prediction associated with the proposed product configuration. The set of instructions, when executed by one or more processors of the device, may cause the device to determine a set of contribution values associated with portions of the proposed product configuration. The set of instructions, when executed by one or more processors of the device, may cause the device to generate instructions for a user interface (UI) that includes text indicating the prediction and a graph indicating the set of contribution values. The set of instructions, when executed by one or more processors of the device, may cause the device to output the instructions for the UI.

### BRIEF DESCRIPTION OF THE DRAWINGS

FIGS. 1A-1C are diagrams of an example implementation relating to transparent modeling based on specific features, in accordance with some embodiments of the present disclosure.

FIGS. 2A-2B are diagrams illustrating an example of training and using a machine learning model in connection with systems and/or methods described herein, in accordance with some embodiments of the present disclosure.

FIGS. 3A-3B are diagrams of example UIs associated with transparent modeling based on specific features, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to transparent modeling based on specific features, in accordance with some embodiments of the present disclosure.

### DETAILED DESCRIPTION

The following detailed description of example implementations refers to the accompanying drawings. The same reference numbers in different drawings may identify the same or similar elements.

In the computer hardware industry, predicting market demand for specific product configurations conserves computing resources and raw materials that would otherwise be wasted on designing and building unpopular product configurations.

Additionally, many existing machine learning models, whether for predicting market demand or other purposes, are opaque. In particular, many machine learning models are black box models so that predictions for different product configurations cannot be broken down by feature. As a result, selecting product configurations to input into the machine learning models is random and results in wasted computing resources.

Some implementations described herein provide a machine learning model for accurately predicting outcomes associated with different product configurations. In some implementations, the machine learning model receives item-level data from one data source and feature-level data from another data source and preprocesses the data to correlate historical sales data to specific components and features. As a result, accuracy of the machine learning model is increased as compared with models that do not combine datasets in order to obtain feature-level data.

Additionally, the machine learning model assesses specific components and features using SHAP values. As a result, transparency is improved as compared with a black box model. Additionally, the SHAP values may be included in visualizations along with a predicted outcome in order to allow for easy understanding of the contributions of each component and feature.

The clarity provided by the SHAP values not only improves transparency but also conserves computing resources. For example, a user may select product configurations to input to the machine learning model based on the SHAP values, which conserves computing resources that otherwise would have been wasted in applying the machine learning model to product configurations that are unlikely to succeed.

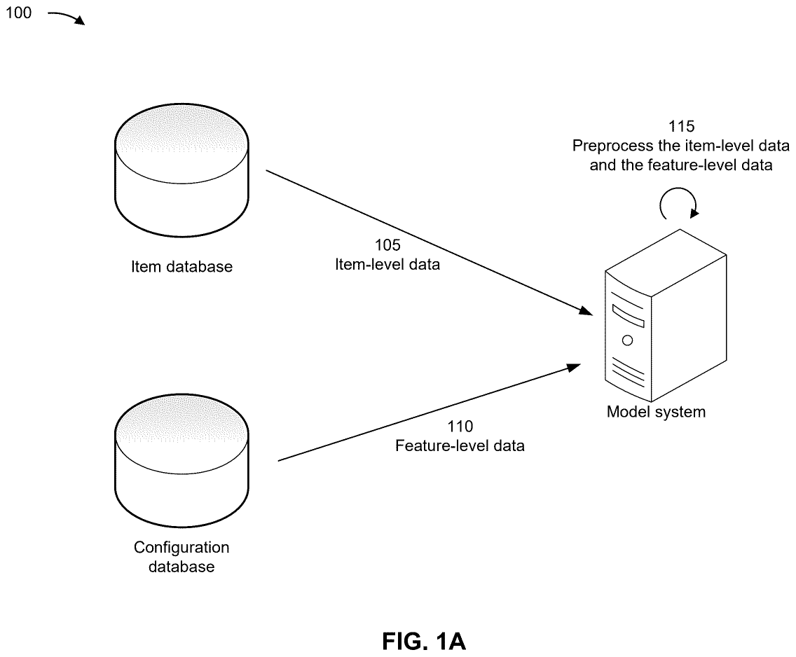

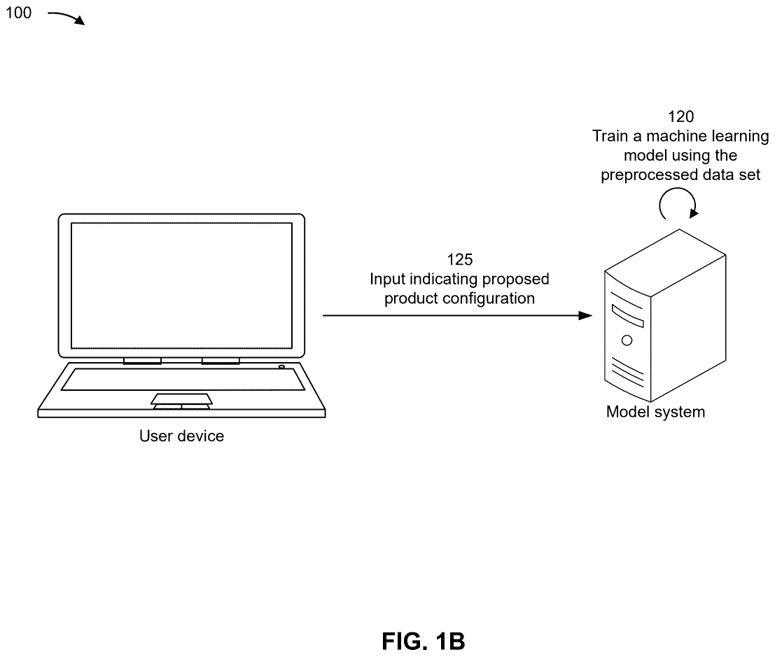

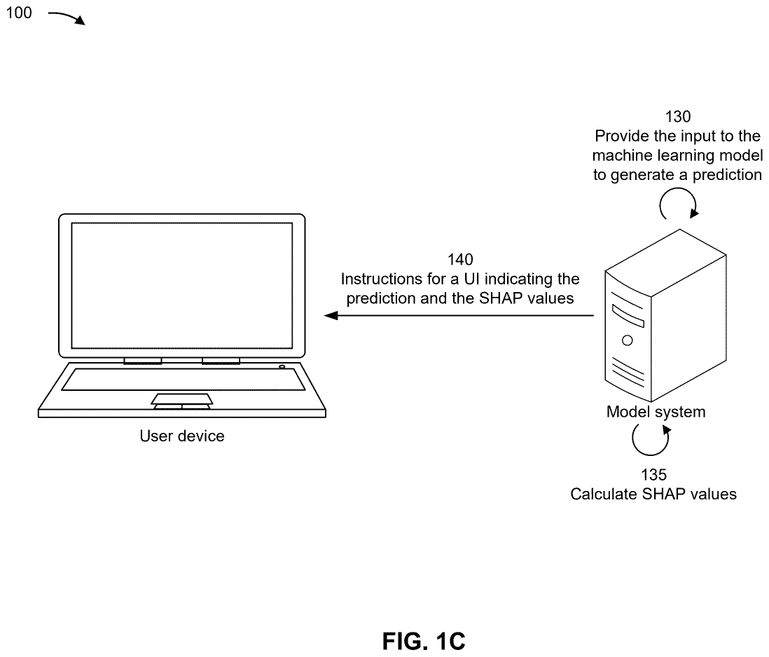

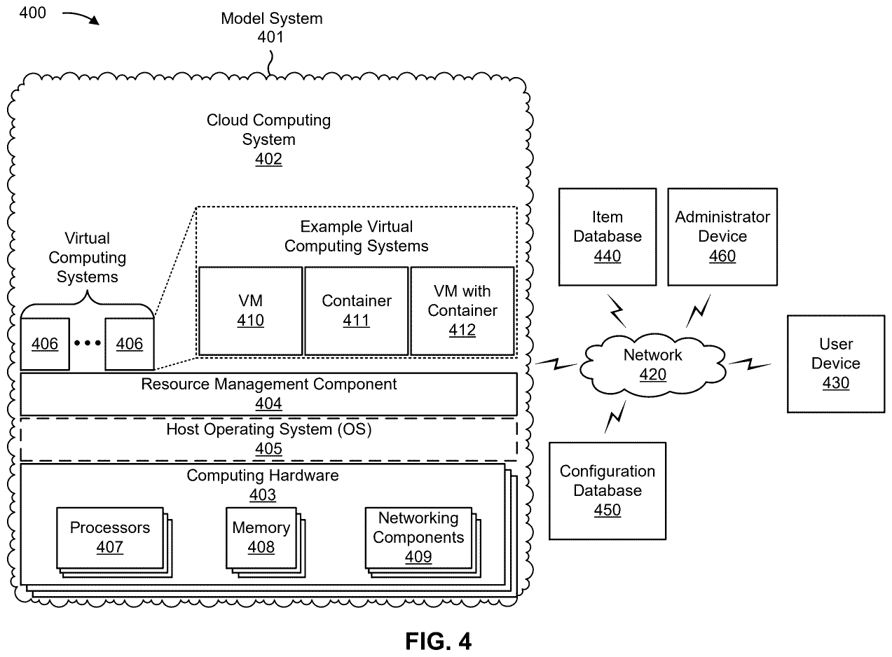

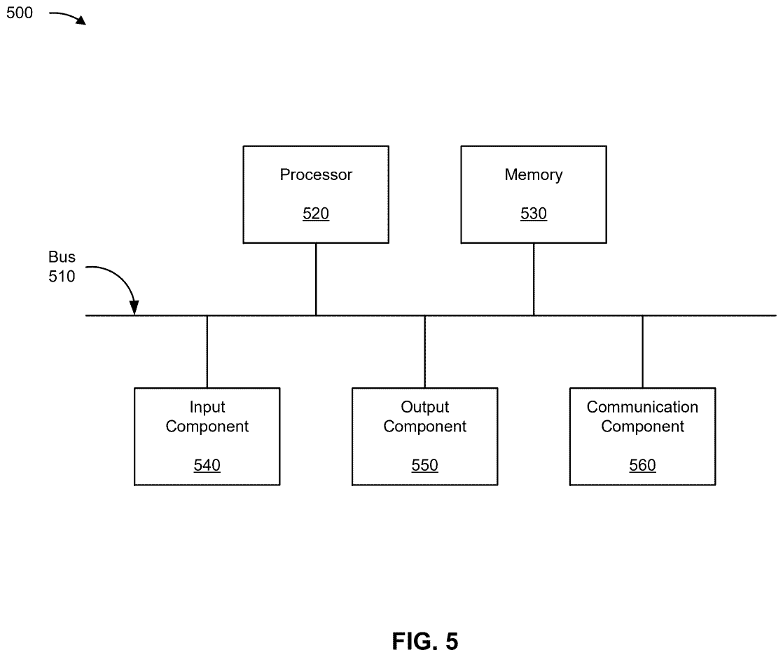

FIGS. 1A-IC are diagrams of an example 100 associated with transparent modeling based on specific features. As shown in FIGS. 1A-1C, example 100 includes a model system, an item database, a configuration database, and a user device. These devices are described in more detail in connection with FIGS. 4 and 5.

As shown in FIG. 1A and by reference number 105, the item database may transmit, and the model system may receive, item-level data. The item-level data may include item identifiers (e.g., model numbers or order numbers, among other examples), sales data (e.g., prices and quantities sold, among other examples), and time information (e.g., order dates or delivery dates, among other examples). The item-level data may be encoded as tabular data or in another type of relational data structure (e.g., searchable via structure query language (SQL) queries), or in a NoSQL data structure.

In some implementations, the model system may transmit, and the item database may receive, a request for the item-level data (e.g., for item-level data within a date range or within a category, among other examples). The item database may transmit, and the model system may receive, the item-level data in response to the request. Alternatively, the item database may push the item-level data to the model system (rather than the model system pulling the item-level data from the item database). For example, the item database may transmit new item-level data to the model system when the new item-level data is available (e.g., is created in the item database).

Although the example 100 is described in connection with the item database, other examples may include a first data source providing the item-level data.

As shown by reference number 110, the configuration database may transmit, and the model system may receive, feature-level data. The item-level data may include product configuration identifiers (e.g., stock keeping units (SKUs), among other examples) and specific components or features associated with product configurations. The feature-level data may be encoded as tabular data or in another type of relational data structure, or in a NoSQL data structure.

Although the example 100 is described in connection with the item database, other examples may include a second data source providing the feature-level data.

As shown by reference number 115, the model system may preprocess the item-level data and the feature-level data to correlate historical item data to specific components and features. For example, the model system may join the specific components and features (in the feature-level data) to corresponding entries (in the item-level data) to enable a machine learning model to identify one or more successful product configurations, as described below. Therefore, the model system may preprocess product configuration details (in the feature-level data) with item-level information (in the item-level data) to create a preprocessed dataset associated with product configurations.

Combining the item-level data and the feature-level data increases accuracy of the machine learning model. In particular, predictions about product configurations are more accurate by account for specific components and features included in the product configurations.

In some implementations, the model system may additionally standardize the item-level data across multiple currencies and/or standardize the feature-level data across multiple measurement units. For example, the model system may ensure that the historical item data may be compared across countries and/or that the specific components and features may be compared by processor speed or other units. The model system may additionally encode product configuration details into a numerical format for the preprocessed dataset. For example, a product configuration may be represented as a multi-variable vector that encodes the specific components and features of the product configuration. The model system may exclude records with missing attributes from the preprocessed dataset in order to further improve accuracy.

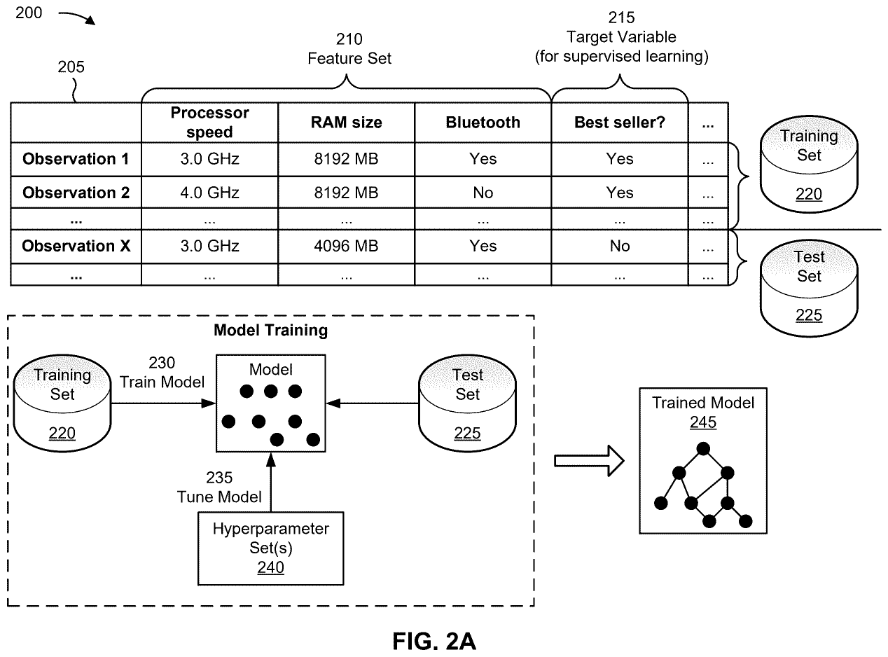

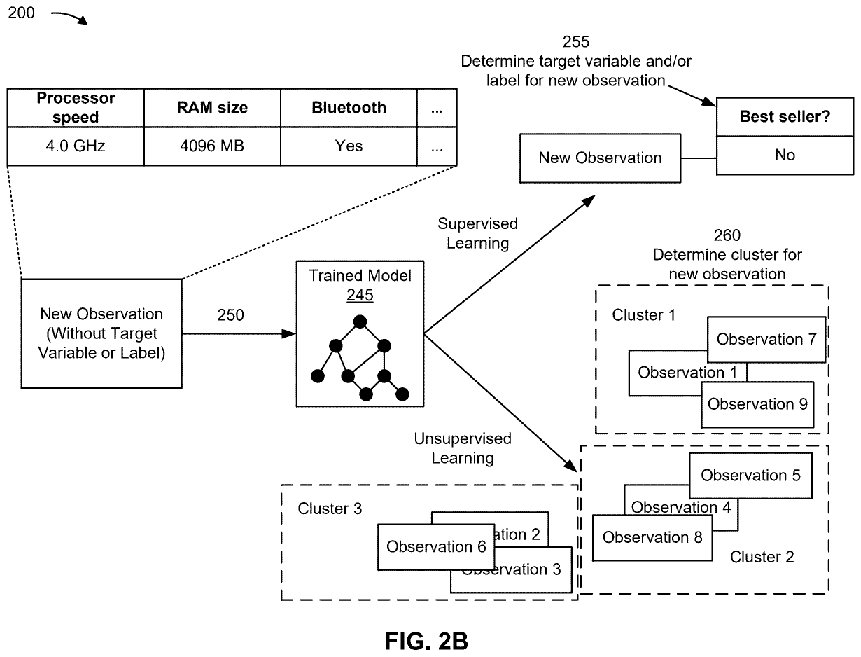

As shown in FIG. 1B and by reference number 120, the model system may train the machine learning model using the preprocessed dataset. Accordingly, the model system may train the machine learning model using the historical item data correlated to the specific components and features. The machine learning model may be trained using a gradient boosting algorithm and/or as described in connection with FIG. 2A. In some implementations, the machine learning model may include a classifier and a regression model. For example, the classifier may predict whether a product configuration is going to be a bestseller, and the regression model may predict how many units of the product configuration will sell.

The specific components and features considered by the machine learning model may include a form factor, a weight, a battery life, a build material, a connectivity option, a graphics capability, a memory capacity, a processor speed, a security feature, a hard disk configuration, or a quantity of expansion slots. In some implementations, the model system may rank the specific components and features using exploratory data analysis for training the machine learning model. For example, the model system may estimate (e.g., using regression and/or another mathematical technique) which components and features are more likely to affect outcomes of product configurations. Accordingly, the model system may train the machine learning model with heavier weighting toward the components and features that are more likely to affect outcomes.

As shown by reference number 125, the user device may transmit, and the model system may receive, input indicating a proposed product configuration. For example, the input may include a data structure that encodes a list of components and features for the proposed product configuration. In some implementations, a user of the user device may interact with the user device (e.g., via an input component) to trigger the user device to transmit the input. For example, the user device may output a UI (e.g., via an output component), and the user may interact with the UI to trigger the user device to transmit the input. Alternatively, the user may provide text-based input (e.g., to a command line or another shell) to trigger the user device to transmit the input.

As shown in FIG. 1C and by reference number 130, the model system may provide the input to the machine learning model to generate a prediction associated with the proposed product configuration. For example, the model system may use the machine learning model to predict an outcome associated with the proposed product configuration. In some implementations, the outcome may include a binary output from the classifier of the machine learning model, such as a classification indicating whether the proposed product configuration will be a best seller. Additionally, or alternatively, the outcome may include a numerical output from the regression model of the machine learning model, such as a predicted quantity of units within a time period for the proposed product configuration.

In some implementations, the input from the user device may indicate an output preference (e.g., for either a classification output or a numerical output). Accordingly, the model system may provide the input to the classifier or to the regression model based on the output preference.

As shown by reference number 135, the model system may calculate SHAP values to indicate a plurality of contributions associated with the specific components and features to the outcome. For example, the model system may calculate a SHAP value for an individual feature within a set of features for the proposed product configuration, and the SHAP value may indicate a contribution of the individual feature to the prediction. Although the example 100 is described using SHAP values, other contribution values may be determined that indicate how different components and features affect the prediction.

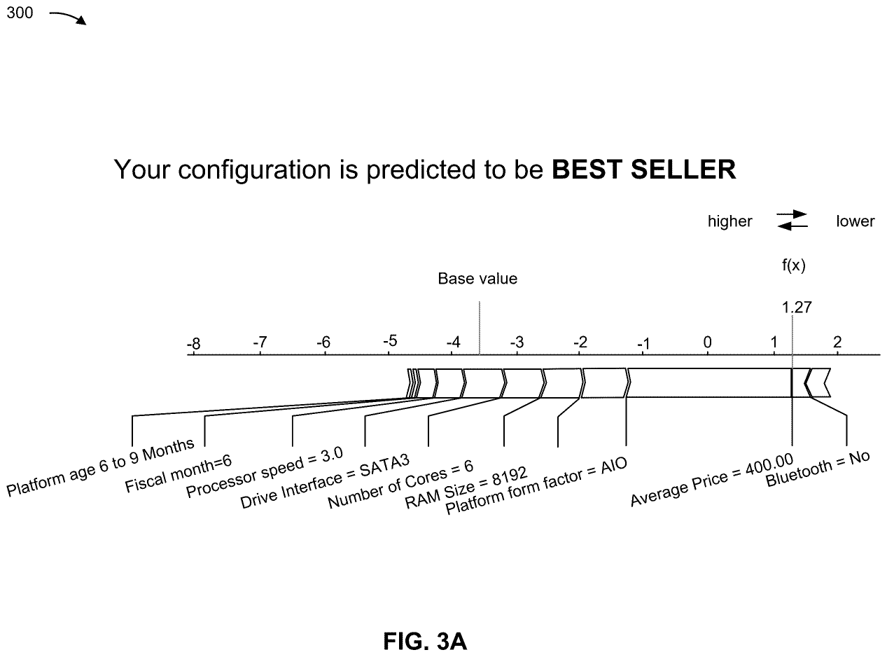

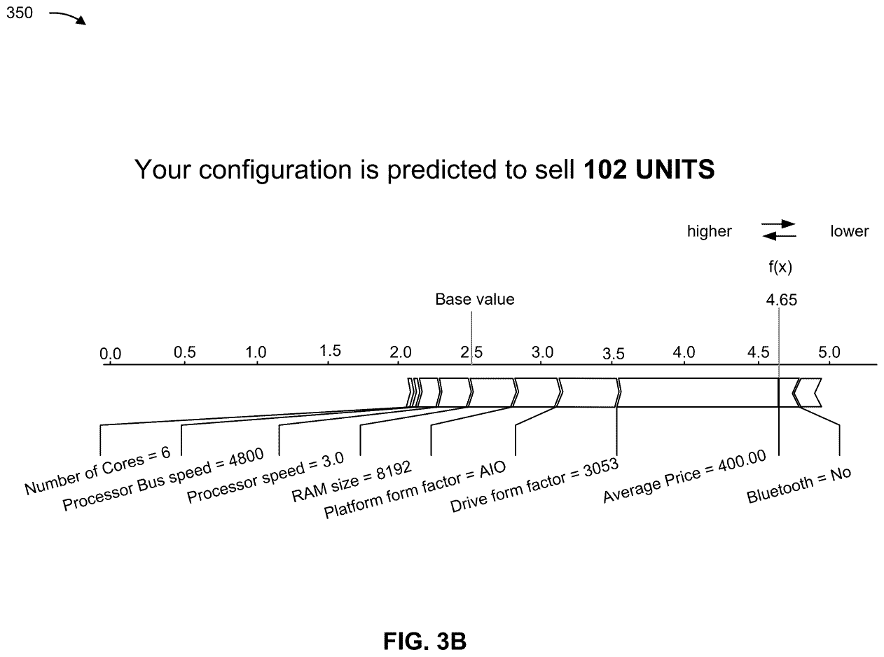

As shown by reference number 140, the model system may transmit, and the user device may receive, instructions for a UI that indicates the prediction and the SHAP values. For example, as described in connection with FIGS. 3A-3B, the UI may include text indicating the prediction and a graph indicating the set of contribution values. For example, the graph may be a bar graph. In some implementations, the SHAP values may be represented as differentials relative to a base value, as shown in FIGS. 3A-3B. Therefore, the model system may output an indication of the prediction (e.g., in text) with the SHAP values (e.g., in a visualization).

By using techniques as described in connection with FIGS. 1A-IC, the machine learning model increases accuracy by combining the item-level data with the feature-level data. Additionally, the SHAP values provide transparency for the machine learning model and improve input to the machine learning model (e.g., from the user device).

As indicated above, FIGS. 1A-1C are provided as an example. Other examples may differ from what is described with regard to FIGS. 1A-IC.

FIGS. 2A and 2B are diagrams illustrating an example 200 of training and using a machine learning model in connection with transparent modeling based on specific features. The machine learning model training described herein may be performed using a machine learning system. The machine learning system may include or may be included in a computing device, a server, a cloud computing environment, or the like, such as a model system described in more detail below.

As shown by reference number 205, a machine learning model may be trained using a set of observations. The set of observations may be obtained and/or input from training data (e.g., historical data), such as data gathered during one or more processes described herein. For example, the set of observations may include data gathered from an item database and/or a configuration database, as described elsewhere herein. In some implementations, the machine learning system may receive the set of observations (e.g., as input) from an administrator device.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the administrator device. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a processor speed, a second feature of a random access memory (RAM) size, a third feature of Bluetooth® availability, and so on. As shown, for a first observation, the first feature may have a value of 3.0 gigahertz (GHz), the second feature may have a value of 8192 megabytes (MB), the third feature may have a value of Yes, and so on. These features and feature values are provided as examples, and may differ in other examples. For example, the feature set may include one or more of the following features: a form factor, a weight, a battery life, a build material, a connectivity option (other than Bluetooth), a graphics capability, a security feature, a hard disk configuration, and/or a quantity of expansion slots. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is whether a product configuration represented by the feature set will be a best seller, which has a value of Yes for the first observation.

The feature set and target variable described above are provided as examples, and other examples may differ from what is described above. For example, the target variable may be a quantity of units expected to sell for the product configuration represented by the feature set.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 2B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B is a diagram illustrating applying the trained machine learning model 245 to a new observation. As shown by reference number 250, the machine learning system may receive a new observation (or a set of new observations), and may input the new observation to the machine learning model 245. As shown, the new observation may include a first feature of 4.0 GHZ, a second feature of 4096 MB, a third feature of Yes, and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a value of No for the target variable of whether a product configuration will be a best seller for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as a recommendation not to market the product configuration represented by the new observation. Additionally, or alternatively, the machine learning system may perform an automated action and/or may cause an automated action to be performed (e.g., by instructing another device to perform the automated action), such as generating text indicating that the product configuration represented by the new observation will not be a best seller. As another example, if the machine learning system were to predict a value of Yes for the target variable of whether the product configuration will be a best seller, then the machine learning system may provide a different recommendation (e.g., a recommendation to market the product configuration represented by the new observation) and/or may perform or cause performance of a different automated action (e.g., generating text indicating that the product configuration represented by the new observation will be a best seller). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) the new observation in a cluster, as shown by reference number 260. The observations within a cluster may have a threshold degree of similarity. As an example, if the machine learning system classifies the new observation in a first cluster (e.g., unlikely to be a best seller), then the machine learning system may provide a first recommendation, such as a recommendation not to market the product configuration represented by the new observation. Additionally, or alternatively, the machine learning system may perform a first automated action and/or may cause a first automated action to be performed (e.g., by instructing another device to perform the automated action) based on classifying the new observation in the first cluster, such as generating text indicating that the product configuration represented by the new observation will not be a best seller. As another example, if the machine learning system were to classify the new observation in a second cluster (e.g., likely to be a best seller), then the machine learning system may provide a second (e.g., different) recommendation (e.g., a recommendation to market the product configuration represented by the new observation) and/or may perform or cause performance of a second (e.g., different) automated action, such as generating text indicating that the product configuration represented by the new observation will be a best seller.

In this way, the machine learning system may apply a rigorous and automated process to predicting outcomes for product configurations. The machine learning system may use feature-level data (e.g., as shown in FIGS. 3A-3B) to improve accuracy. Additionally, the machine learning system may allow for contributions of different features to be measured (e.g., using SHAP values) in order to improve transparency.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIGS. 3A and 3B are diagrams of example UIs 300 and 350, respectively, associated with transparent modeling based on specific features. The example UIs 300 or 350 may be output by a user device (e.g., an output component of the user device) based on instructions from a model system. These devices are described in more detail in connection with FIGS. 4 and 5.

As shown in FIG. 3A, the example UI may include text that encodes output from a classifier (e.g., “Your configuration is predicted to be BEST SELLER”) for a proposed product configuration. The example UI 300 further includes a bar graph representing contribution values for each component or feature in the proposed product configuration. In the example UI 300, a platform age, a launch date, a processor speed, a hard drive interface, a quantity of cores, a RAM size, a platform form factor, and an estimated price all increase predicted sales of the proposed product configuration relative to a base value. On the other hand, a lack of Bluetooth capability decreases predicted sales of the proposed product configuration relative to the base value.

FIG. 3B is similar to FIG. 3A but includes text that encodes output from a regression model (e.g., “Your configuration is predicted to sell 102 UNITS”). Additionally, in the example UI 350, a quantity of cores, a processor bus speed, a processor speed, a RAM size, a platform form factor, a drive form factor, and an estimated price increase predicted sales of the proposed product configuration relative to a base value. On the other hand, a lack of Bluetooth capability decreases predicted sales of the proposed product configuration relative to the base value.

As indicated above, FIGS. 3A-3B are provided as examples. Other examples may differ from what is described with regard to FIGS. 3A-3B.

FIG. 4 is a diagram of an example environment 400 in which systems and/or methods described herein may be implemented. As shown in FIG. 4, environment 400 may include a model system 401, which may include one or more elements of and/or may execute within a cloud computing system 402. The cloud computing system 402 may include one or more elements 403-412, as described in more detail below. As further shown in FIG. 4, environment 400 may include a network 420, a user device 430, an item database 440, a configuration database 450, and/or an administrator device 460. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the model system 401 may include one or more elements 403-412 of the cloud computing system 402, may execute within the cloud computing system 402, and/or may be hosted within the cloud computing system 402, in some implementations, the model system 401 may not be cloud-based (e.g., may be implemented outside of a cloud computing system) or may be partially cloud-based. For example, the model system 401 may include one or more devices that are not part of the cloud computing system 402, such as device 500 of FIG. 5, which may include a standalone server or another type of computing device. The model system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 430 may include one or more devices capable of receiving, generating, storing, processing, and/or providing information associated with product configurations, as described elsewhere herein. The user device 430 may include a communication device and/or a computing device. For example, the user device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 430 may communicate with one or more other devices of environment 400, as described elsewhere herein.

The item database 440 may include one or more devices capable of receiving, generating, storing, processing, and/or providing information associated with item-level data, as described elsewhere herein. The item database 440 may include a communication device and/or a computing device. For example, the item database 440 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The item database 440 may communicate with one or more other devices of environment 400, as described elsewhere herein.

The configuration database 450 may include one or more devices capable of receiving, generating, storing, processing, and/or providing information associated with feature-level data, as described elsewhere herein. The configuration database 450 may include a communication device and/or a computing device. For example, the configuration database 450 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The configuration database 450 may communicate with one or more other devices of environment 400, as described elsewhere herein.

The administrator device 460 may include one or more devices capable of receiving, generating, storing, processing, and/or providing information associated with product configurations, as described elsewhere herein. The administrator device 460 may include a communication device and/or a computing device. For example, the administrator device 460 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 460 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with transparent modeling based on specific features. The device 500 may correspond to a user device 430, an item database 440, a configuration database 450, and/or an administrator device 460. In some implementations, a user device 430, an item database 440, a configuration database 450, and/or an administrator device 460 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include RAM, read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

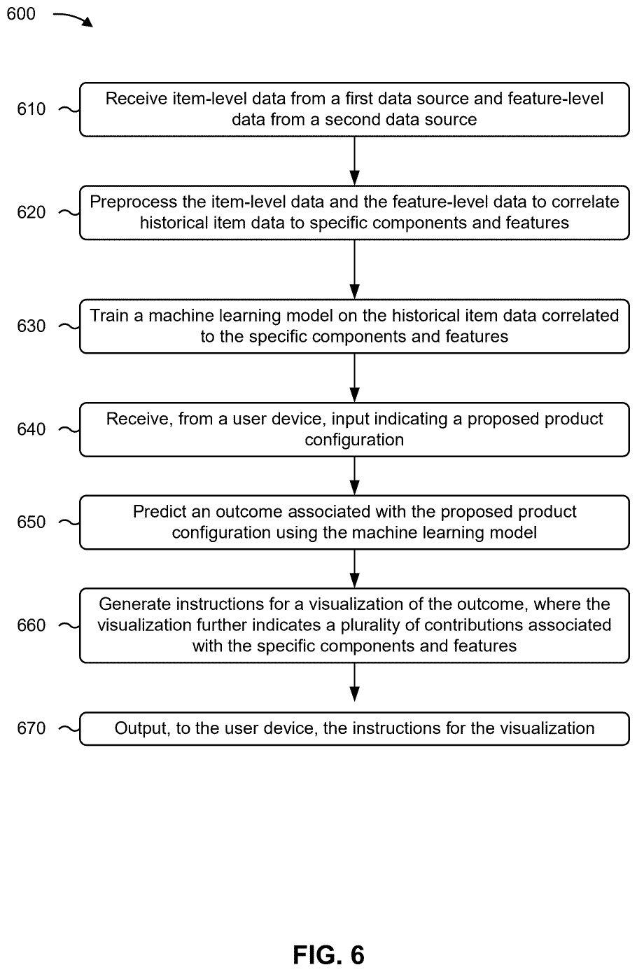

FIG. 6 is a flowchart of an example process 600 associated with transparent modeling based on specific features. In some implementations, one or more process blocks of FIG. 6 are performed by a model system (e.g., model system 401). In some implementations, one or more process blocks of FIG. 6 are performed by another device or a group of devices separate from or including the model system, such as a user device 430, an item database 440, a configuration database 450, and/or an administrator device 460. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving item-level data from a first data source and feature-level data from a second data source (block 610). For example, the model system may receive item-level data from a first data source and feature-level data from a second data source, as described herein.

As further shown in FIG. 6, process 600 may include preprocessing the item-level data and the feature-level data to correlate historical item data to specific components and features (block 620). For example, the model system may preprocess the item-level data and the feature-level data to correlate historical item data to specific components and features, as described herein.

As further shown in FIG. 6, process 600 may include training a machine learning model on the historical item data correlated to the specific components and features (block 630). For example, the model system may train a machine learning model on the historical item data correlated to the specific components and features, as described herein.

As further shown in FIG. 6, process 600 may include receiving, from a user device, input indicating a proposed product configuration (block 640). For example, the model system may receive, from a user device, input indicating a proposed product configuration, as described herein.

As further shown in FIG. 6, process 600 may include predicting an outcome associated with the proposed product configuration using the machine learning model (block 650). For example, the model system may predict an outcome associated with the proposed product configuration using the machine learning model, as described herein.

As further shown in FIG. 6, process 600 may include generating instructions for a visualization of the outcome, where the visualization further indicates a plurality of contributions associated with the specific components and features (block 660). For example, the model system may generate instructions for a visualization of the outcome, where the visualization further indicates a plurality of contributions associated with the specific components and features, as described herein.

As further shown in FIG. 6, process 600 may include outputting, to the user device, the instructions for the visualization (block 670). For example, the model system may output, to the user device, the instructions for the visualization, as described herein.

Process 600 may include additional implementations, such as any single implementation or any combination of implementations described below and/or in connection with one or more other processes described elsewhere herein.

In a first implementation, process 600 includes standardizing the historical item data across multiple currencies, and standardizing the specific components and features across multiple measurement units.

In a second implementation, alone or in combination with the first implementation, the outcome associated with the proposed product configuration includes a predicted quantity of units within a time period and a classification indicating whether the proposed product configuration will be a best seller.

In a third implementation, alone or in combination with one or more of the first and second implementations, the specific components and features include one or more of: a form factor, a weight, a battery life, a build material, a connectivity option, a graphics capability, a memory capacity, a processor speed, a security feature, a hard disk configuration, or a quantity of expansion slots.

In a fourth implementation, alone or in combination with one or more of the first through third implementations, process 600 includes ranking the specific components and features using exploratory data analysis for training the machine learning model.

In a fifth implementation, alone or in combination with one or more of the first through fourth implementations, generating the instructions for the visualization includes generating SHAP values to indicate the plurality of contributions associated with the specific components and features.

In a sixth implementation, alone or in combination with one or more of the first through fifth implementations, preprocessing the item-level data and the feature-level data includes joining the specific components and features to corresponding entries in the historical item data to enable the machine learning model to identify one or more successful product configurations.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations described herein to the precise forms that are described. Modifications and variations may be made in light of the above description or may be acquired from practice of the implementations described herein.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features may be combined in ways not specifically recited in the claims and/or described in the specification. Although each dependent claim listed below may directly depend on only one claim, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for predicting contributions of feature sets to an outcome using shapley additive explanation (SHAP) values, comprising:
one or more processors configured to:
preprocess product configuration details with item-level information from a plurality of databases to create a preprocessed dataset associated with product configurations;
train a machine learning model using the preprocessed dataset and a gradient boosting algorithm, wherein the machine learning model includes a classifier and a regression model;
generate a prediction associated with a proposed product configuration using the machine learning model, wherein the prediction includes a binary output from the classifier and a numerical output from the regression model;
calculate the SHAP values for individual features within a set of features for the proposed product configuration to determine a contribution of each feature in the set of features to the prediction; and
output an indication of the prediction with the SHAP values.

2. The device of claim 1, wherein the one or more processors are further configured to:
encode the product configuration details into a numerical format for the preprocessed dataset.

3. The device of claim 1, wherein the one or more processors are further configured to:
exclude records with missing attributes from the preprocessed dataset.

4. The device of claim 1, wherein, to output the indication of the prediction with the SHAP values, the one or more processors are configured to:
output instructions for an interface that displays the prediction in text along with a graph showing the SHAP values relative to a base value.

5. The device of claim 4, wherein the text comprises the binary output from the classifier.

6. The device of claim 4, wherein the text comprises the numerical output from the regression model.

7. A method, comprising:
receiving, by a model system, item-level data from a first data source and feature-level data from a second data source;
preprocessing, by the model system, the item-level data and the feature-level data to correlate historical item data to specific components and features;
training, by the model system, a machine learning model on the historical item data correlated to the specific components and features;
receiving, by the model system and from a user device, input indicating a proposed product configuration;
predicting, by the model system, an outcome associated with the proposed product configuration using the machine learning model;
generating, by the model system, instructions for a visualization of the outcome, wherein the visualization further indicates a plurality of contributions associated with the specific components and features; and
outputting, by the model system and to the user device, the instructions for the visualization.

8. The method of claim 7, further comprising:
standardizing, by the model system, the historical item data across multiple currencies; and
standardizing, by the model system, the specific components and features across multiple measurement units.

9. The method of claim 7, wherein the outcome associated with the proposed product configuration comprises:
a predicted quantity of units within a time period; and
a classification indicating whether the proposed product configuration will be a best seller.

10. The method of claim 7, wherein the specific components and features comprise one or more of:
a form factor;
a weight;
a battery life;
a build material;
a connectivity option;
a graphics capability;
a memory capacity;
a processor speed;
a security feature;
a hard disk configuration; or
a quantity of expansion slots.

11. The method of claim 7, further comprising:
ranking, by the model system, the specific components and features using exploratory data analysis for training the machine learning model.

12. The method of claim 7, wherein generating the instructions for the visualization comprises:
generating, by the model system, shapley additive explanation (SHAP) values to indicate the plurality of contributions associated with the specific components and features.

13. The method of claim 7, wherein preprocessing the item-level data and the feature-level data comprises:
joining, by the model system, the specific components and features to corresponding entries in the historical item data to enable the machine learning model to identify one or more successful product configurations.

14. A non-transitory computer-readable medium storing a set of instructions, the set of instructions comprising:
one or more instructions that, when executed by one or more processors of a device, cause the device to:
receive input indicating a proposed product configuration;
provide the input to a machine learning model to generate a prediction associated with the proposed product configuration;
determine a set of contribution values associated with portions of the proposed product configuration;
generate instructions for a user interface (UI) that includes text indicating the prediction and a graph indicating the set of contribution values; and
output the instructions for the UI.

15. The non-transitory computer-readable medium of claim 14, wherein the set of contribution values comprises a set of shapley additive explanation (SHAP) values.

16. The non-transitory computer-readable medium of claim 14, wherein the machine learning model includes a classifier and a regression model.

17. The non-transitory computer-readable medium of claim 16, wherein the prediction includes a binary output from the classifier, a numerical output from the regression model, or a combination thereof.

18. The non-transitory computer-readable medium of claim 16, wherein the input indicates an output preference, and wherein the one or more instructions, that cause the device to provide the input to the machine learning model, cause the device to provide the input to the classifier or to the regression model based on the output preference.

19. The non-transitory computer-readable medium of claim 14, wherein the graph comprises a bar graph.

20. The non-transitory computer-readable medium of claim 14, wherein the set of contribution values are represented as differentials relative to a base value.
